(19) United States
(12) Patent Application Publication
(10) Pub. No.: US 2016/0037940 A1
(43) Pub. Date: Feb. 11, 2016

(54) Durable insect netting

(71) Applicant: Jacques C. Bertrand, Gainesville, FL (US)

(72) Inventor: Jacques C. Bertrand, Gainesville, FL (US)

(21) Appl. No.: 14/582,456

(22) Filed: Dec. 24, 2014

Related U.S. Application Data
(60) Provisional application No. 61/924,895, filed on Jan. 8, 2014.

(51) Int. Cl. A47C 29/00; D04H 3/004; B29C 65/48; D04H 13/00

(52) U.S. Cl. CPC A47C 29/00; D04H 13/008; D04H 3/004; B29C 65/4805; D10B 2101/06; D10B 2403/0242; D10B 2507/02

(57) ABSTRACT

A netting material, useful for insect netting, comprising a glass yarn fiber material with increased durability over currently available netting material. The glass yarn fiber material contains glass filaments extruded such that the filaments and ensuing glass yarn fibers contain a small diameter. The yarn fibers permit flexibility of the material and ready light penetration and ventilation. The material can be coated with a plastic, such as PVC as well as insecticides, and other biocides.

### CROSS-REFERENCES TO RELATED APPLICATIONS

The application claims priority to U.S. provisional application No. 61/924,895 filed Jan. 8, 2014, which is incorporated by reference, herein.

### FIELD OF THE INVENTION

The inventive subject matter relates to a durable and safer to use insect netting comprising a fiberglass weave material. The weave can be coated with insecticide or insect repellent.

### BACKGROUND OF INVENTION

Current materials used in fabricating insect netting predominantly includes: cotton, polyester, polyethylene, polyamide/nylon, or polypropylene. The materials currently employed for insect netting do not tend to be structurally strong. Frequently, only moderate use results in holes in the netting permitting insects, such as mosquitoes, through the netting, obviating the value of the net. Thicker filaments or weaves comprising these materials tend to limit the entry of light and ventilation. Additionally, due to the chemical nature of these materials, dirt is likely to be retained, which leads to acceleration of deterioration of the fabric. The accumulated dirt can also lead to mold and bacterial accumulation, which is a health hazard. Also, these materials are often not flame retardant, posing a further health risk.

Netting material is critical in controlling insect-borne diseases, especially in warmer climates or when operating under field conditions. Cost-effective, light and rugged netting materials are, therefore, important considerations in netting design.

### SUMMARY OF INVENTION

An object of this invention is a netting material or mesh for protection against flying insects. The material comprises a netting mesh made of inter-woven glass yarn fibers. Important aspect of the glass yarn fiber is that the fibers have a relatively small diameter. The glass yarn fiber can then be coated with plastic such as polyvinyl chloride (i.e., PVC).

This structural feature of the material enables a netting material with increased durability and safety, such as resistance to burning, over insect nets made with currently used materials such as cotton or cotton/polyester blends.

Another object of the invention is a durable insect netting material that permits adequate light penetration, ventilation and improved safety. The inventive netting material, since it is made of glass, would be fire resistant. A still further object of the invention is a netting material that provides a physical barrier against flying insects that is durable and that can also contains insecticides or insect repellents.

### BRIEF DESCRIPTION OF DRAWINGS

FIG. 1. Diagram of net construction and fiberglass material application.

FIG. 2. Illustration of netting weave. Panel (A) illustrates netting components showing cross-points of glass fiber yarn. Panel (B) illustrates an example of netting showing a mesh with uniformity of hole size.

FIG. 3. Illustration of glass filaments and glass yarn fibers. Illustrated is a glass filament that comprise glass yarn fibers. The glass yarn fibers can be twisted into a bundle to form glass yarn fiber bundles.

### DETAILED DESCRIPTION OF PREFERRED EMBODIMENTS

As used herein, mesh refers to material comprising fibers with open spaces between the fibers. Glass filaments are glass extruded into long strands. Glass yarn fibers are glass filaments twisted together. Glass yarn fiber bundle is two or more glass yarn fibers twisted together.

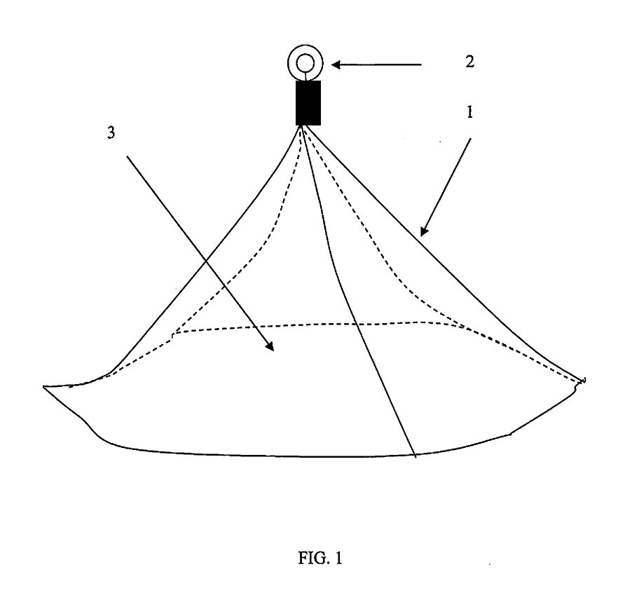

The invention relates to a netting material for protection against flying insects that has improved durability over existing netting materials. An example of a configuration where the netting material can be utilized is the insect net illustrated in the diagram of FIG. 1. In FIG. 1, the netting material (1) is anchored at one end by a platform, ring or bar (2) that comprises a fastener to hold the netting and permit the netting material to “drape” or cover the protected area (3).

Important considerations for design of the netting material is that the material must be rugged and resistant to tear, especially under field conditions. The material must also enable light to enter through the draped netting and allow adequate air circulation. The material must also be light and flexible in order to permit the netting to drape around the area to properly seal around the area to be shielded from insects.

Current materials used in insect netting are made of materials that permit the netting to drape around the area to be protected. These include cotton or cotton polyester blends, polyethylene, polyamide/nylon and polypropylene materials. However, these materials tend to tear easily. Furthermore, they are not resistant to fire and either melt or actually burn when exposed to heat.

Materials that are more rugged, such as fiberglass, which are used in tents are typically too stiff to be effective netting material. Stiff materials, such as current formulations of fiberglass, used, for example, in tents, tend to be too stiff. The stiffness allows for gaps around the protected area where insects can enter.

The inventive device comprises a netting material for use as an insect barrier that comprises thin glass filaments that are woven by twisting the glass filaments together to produce a yarn fiber. This material is flexible to permit the necessary draping to minimize gaps where insects can enter. Furthermore, unlike current materials used in insect nets, the inventive netting material can be made fire retardant or fire proof.

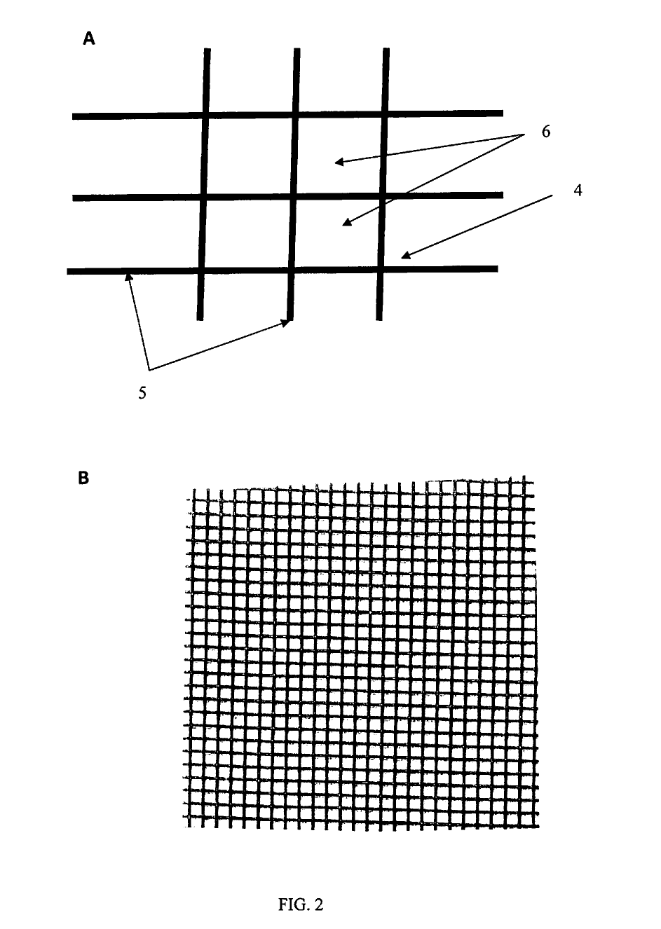

The fibers can be woven into a netting material to obtain different mesh sizes or configuration. In one embodiment, as illustrated in FIG. 2 (A), the mesh comprises cross-points (4) of the yarn fibers (5), creating holes that can have sizes over a range of sizes in the mesh. In this embodiment, the cross-points of weave of yarn fibers (5) are bonded, creating a tear-resistant structure that is also puncture resistant. FIG. 2 (B) illustrates a mesh with equal sized holes.

As used herein, glass filaments are glass that are extruded or stretched. In a preferred embodiment, the glass is extruded to produce a thin glass filament 5.0 to 7.0 microns in diameter. However, in other embodiments, the glass filaments can be less than 5.0 or greater than 7.0 microns in diameter.

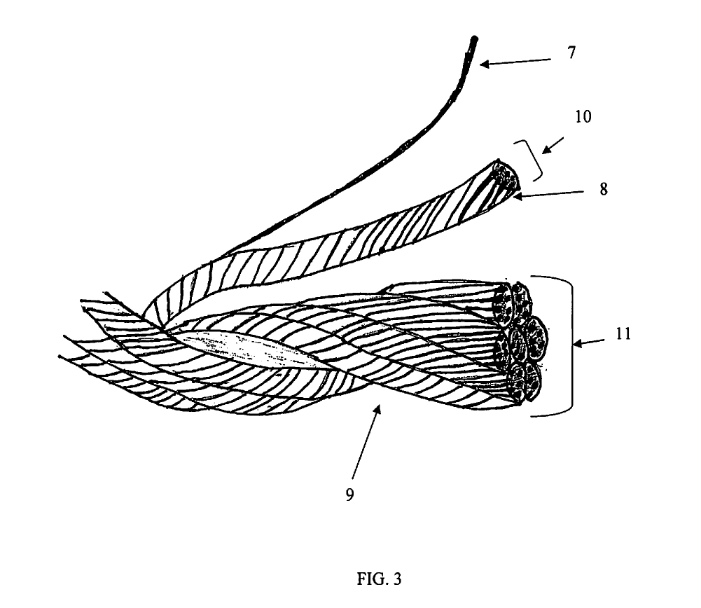

The relationship between glass filaments and yarn fibers is illustrated in FIG. 3. In FIG. 3, two or more glass filaments (7) are twisted to form a glass yarn fiber (8). Two or more glass yarn fibers can be twisted together to form a glass yarn fiber bundle (9).

A single yarn fiber can contain any number of glass filaments. However, in a preferred embodiment, a yarn fiber contains 200 to 300 glass filaments twisted together. However, in other embodiments, yarn fibers can also contain less than 200 glass filaments or greater than 500 glass filaments.

The thinness of the glass filaments and, therefore, the yarn fibers of the mesh is necessary to permit draping of the net to avoid any open areas where insects could enter. Large diameter yarn would be excessively stiff and not result in enclosure of the desired area. The thin fibers permit the netting material to be relatively flexible so that the netting is capable of freely draping over and around an area without a frame structure, such as in a tent. The flexibility of yarn fibers enable the netting to reflect the contours of its surrounding area, such as the ground or a bed, to ensure that minimal gaps exist whereby insects can enter.

The protected area can range from a bed to a small area such as a person lying in a sleeping bag on the ground, as illustrated in FIG. 1. In one embodiment, the yarn fiber is 0.004 to 0.02 inches in diameter (10) (FIG. 3). However yarn with less than 0.004 or greater than 0.02 inches are also envisioned. In other embodiments, yarn fibers containing fewer glass filaments can also be twisted together to form glass yarn fiber bundles. In one embodiment, the diameter of the bundles is 0.004 to 0.002 inches (11) (FIG. 3), however, diameters greater than or less than this range are also envisioned.

Glass filaments of multiple thicknesses are envisioned to be able to be utilized depending on the application and cost, small glass fiber size permits. This enables physical flexibility of the fibers permitting adequate draping of the net around the area to be protected from flying insects. The thin filaments also enable light transmission and ventilation through the mesh while retaining material strength.

In a preferred embodiment, the glass yarn is coated with a solution of plastic. Although any number of plastics is envisioned to be able to be used, an example plastic is polyvinyl chloride (PVC), which is dissolved in a solvent prior to coating. Coating of the yarn can be by any means, including spraying or dipping the yarn. After dipping the yarn in the PVC (or other plastic), the solvent is allowed to dry leaving the filaments encapsulated in the plastic coating. The coating adds strength to the yarn's weave due to the bonding by the coating of the intersection of the weave. The glass yarn fibers can also be coated with plasticizers, for example phthalates, to make the finished plastic (e.g., PVC) coated material soft and flexible.

In one embodiment, the type of glass used in making the glass filaments is E-glass. However, it is envisioned that the inventive netting fiberglass material can be comprised of glass filaments of any glass type, including A, C, D, E-CR, R, S (and S2) or E. An important feature of the glass type utilized is the ability to be extruded into narrow, small diameter fibers, which are bundled (i.e., twisted) together to form filaments. The diameter of the filaments and number of filaments in the roving (i.e., weight) can vary depending on the netting size, application and desired cost.

Due to the desired small diameter of the yarn fibers, glass filaments, with high tensile strength, is preferred. The high tensile strength would permit extrusion of the glass to the desired small diameters.

A number of different weave patterns are possible due to the flexibility of the small diameter yarn fibers. However, in a preferred embodiment, the cross-points (4) (FIG. 2) are bonded either by annealing of the fibers through application of heat and pressure or by resins. The mesh size provides approximately 25 to 30 holes/cm² (6). In some embodiments smaller holes may be desired due to local conditions where the netting is to be used. A mesh size of 25 holes/cm² is considered acceptable to prevent mosquitoes penetrating the net.

In another embodiment, the plastic coating (e.g., PVC) of the yarn fibers is impregnated with insecticides, insect repellents or ultraviolet light (UV) stabilizers. Examples of suitable insecticides include pyrethroids and permethrin. Additionally, the yarn fibers can be coated with biocides, to prevent mold or other growth on the netting material.

In a preferred embodiment, a bed netting capable of impeding entry by flying insects that is durable and fire resistant is constructed of mesh comprising glass fibers. The configuration of the netting can be constructed in a number of ways. As an example, the netting can be configured as in FIG. 1. In the method, glass fibers are woven into a netting material to obtain different mesh sizes or configuration.

### EXAMPLE

### Comparison of Fiberglass Verses Polyethylene and Polyester Nets

Different parameters of netting materials were examined for suitability in anti-insect netting material. In these studies, durability, stiffness, and flame resistance was evaluated for different netting materials. Compared were nets made of polyethylene (with a Raschel weave); polyester (with a tricot knit) and netting made of fiber glass weave. A summary of the results are presented in Table 1.

TABLE 1

| Characteristic | Fabric Material | | |
|---|---|---|---|
| Breaking strength | Polyethylene | Polyester knit | Fiber glass knit |
| (lbs.)(Wale | knit | | |
| direction) | | | |
| Breaking strength | 36.0 | 14.2 | 59.5 |
| (lbs.) (wale | | | |
| direction) | | | |
| Breaking strength | 20.1 | 11.0 | 65.0 |
| (lbs.) (Course | | | |
| direction) | | | |
| Elongation stretch | 48.5 | 36.7 | 3.3 |
| (%) | | | |
| Elongation to | 169.7 | 83.8 | 3.3 |
| break (%) | | | |
| Ball Burst Strength | 52.8 | 18.8 | 28.4 |
| (lbs) | | | |
| Puncture | 2.0 | 1.4 | 6.0 |
| propagation (Kg) | | | |
| Dimensional | −23 | −10 | 0 |
| stability after | | | |
| launder (Wale | | | |
| direction) | | | |
| Dimensional | 1 | 13 | 0 |
| stability after | | | |
| launder (Course | | | |
| direction) | | | |
| Tear strength | 4.1 | 2.0 | 13.0 |
| (lbs) (Wale | | | |
| direction) | | | |
| Thickness (inches) | 0.22 | 0.008 | 0.011 |
| Snagging | 3-4 | 3-4 | 3-4 |
| resistance | | | |
| Stiffness (warp | 4.55 | 2.39 | 4.55 |
| direction) | | | |
| Flame resistance | 6.5 | 9.3 | 1.3 |
| (inches of burn) | | | |

In the ball bursting strength, the test operates under a constant rate of traverse while the ball pushes through the fabric (i.e., specimen). In the analysis, five specimen were tested for each fabric. The results are illustrated in Table 1. In the puncture propagation test, the tear resistance of a fabric is measured (i.e., due to snagging). This test, therefore, evaluates a puncture that would ultimately result in a tearing of the fabric. The propagation tear resistance testing is done manually. A fabric is mounted and weighted carriage with a pointed probe is dropped from a specified height. The pointed probe must puncture the fabric in order to generate a tear for the test. The length of the tear is measured and used to calculate the force required to propagate the tear.

In the snag resistance evaluation was conducted by the Mace test method using a Mace Snag Tester. The tester was run at 6,000 revolutions. One specimen was tested in each direction for each fabric composition. The results were compared to the Imperial Chemical Industries (ICI) photographic snagging standards in an iCI viewing cabinet. The ICI photographic snagging standards consist of a set of nine photo replicas in which the intermediate rating is indicated as 3-4; 2-3, etc. The density of snagging on the face side opposite the seam on an evaluation area corresponding to the area of the rating standards being used was rated on the following scale: 5, no or insignificant snagging; 4, slight snagging; 3, moderate snagging; 2, severe snagging; 1, very severe snagging. Each fabric was sewn to a black 55% polyester/45% wool plain weave fabric to protect the tester drums from the sharp mace balls.

Examination of the durability/stability of different fabrics after laundering was evaluated. The results are shown in Table 1. In these studies specimens were 15×15 inches and marked in 10-inch segments in three places in the wale or course direction. They specimens were then laundered with a wash temperature of 120° F., using a permanent press wash cycle with a rinse temperature of 80° F. American Association of Textile Chemists and Colorists (AATCC) detergent was used. The drying setting was normal permanent press (medium high) for 30 to 45 minutes of drying time. Each fabric sample was laundered five times. After each cycle the specimens were checked for visibility of their markings. If the markings faded, they were reapplied (marked over the original markings) in order to measure them after the fifth cycle. Four lbs of ballast were used with all fabrics in one bath/dryer at the same time. As illustrated in Table 1, the polyethylene and polyester fabrics showed some strinkage. The polyethylene fabric showed 12-24% in wale direction and 1% growth to 6% strinkage in course direction. The polyester fabric shrank 10 to 17% in the wale direction and grew 6 to 13% in the course direction. No dimensional changes were noted for the fiberglass fabric.

Stiffness of the materials was evaluated in the warp direction. The least stiff material would be most likely to drape the best. In these studies, a Shirley tester was utilized. The results are shown in Table 1. The fiberglass and the polyethylene fabrics had the greatest level of stiffness with the polyester the least.

The flame resistance of the materials was measured by a vertical flame test to check for after-flame, after-glow, char length, melt drip and general flammability properties. The length of the opening, as shown in Table 1, caused by the flame, was greatest on the polyester fabric with the least on the fiberglass. In all samples, no after-flame or after-glow was observed (i.e., zero seconds) once the 12-second flame was removed. None of the samples exhibited melt drip. The fibers melted away from the flame and heat.

In summary, the fiberglass fabric exhibited the best durability. This material also showed the highest breaking strength with a minimal amount of stretching/elongation. This is desirable to avoid deformation in bed netting material, which would degrade the ability of the net to impede entry of insects. The polyethylene had the highest burst strength, however significant stretching was also observed. The fiberglass curst cleanly with little deformation, leaving the area intact. The fiberglass also performed better than the other two fabric materials in the puncture propagation testing. The fiberglass was also the most flame resistant.

The fiberglass material is, conclusively more rugged and potentially safer, due to its flame resistance properties, than other manufactured or natural products used in insect netting. However, as illustrated in Table 1, fiberglass is also stiffer and less prone to proper draping. For this reason, a preferred embodiment is a netting material utilizing a mesh comprising glass filaments, with similar durability properties of fiberglass but with greater ability to drape properly.

Obviously, many modifications and variations of the present invention are possible in light of the above teachings. It is therefore to be understood that, within the scope of the appended claims, the invention may be practiced otherwise than as specifically described.

What is claimed is:

1. A netting comprising a mesh material comprising glass filaments that are woven together to form a glass yarn fiber.

2. The netting of claim 1, wherein 200 to 500 glass filaments are woven together to form said glass yarn fiber.

3. The netting of claim 1, wherein said fibers are 0.008 to 0.02 inches in diameter.

4. The netting of claim 1, wherein said glass yarn fiber is coated with a plastic.

5. The netting of claim 1, wherein said mesh contains 25 to 30 holes/cm².

6. The netting of claim 1, wherein the mesh material contains cross-points of said fibers, wherein said cross-points are bonded together.

7. The netting of claim 1, wherein said mesh material comprises glass yarn fiber bundles, wherein said glass yarn fiber bundles comprises two or more of said glass yarn fibers that are twisted together.

8. The netting of claim 1, wherein said fibers are coated with an insecticide or insect repellent.

9. The netting of claim 1, wherein said netting is an insect netting.

10. The netting of claim 4, wherein said plastic is polyvinyl chloride.

11. The netting of claim 8, wherein said insecticide is pyrethroids or permethrin.

12. Method of screening against flying insects comprising forming a barrier wherein said barrier is a netting comprising glass filaments as in claim 1.

13. The method of claim 12, wherein said 200 to 500 glass filaments are woven together to form said glass yarn fiber.

14. The method of claim 12, wherein the mesh material contains cross-points of said fibers, wherein said cross-points are bonded together.

15. The method of claim 12, wherein said mesh material comprises glass yarn fiber bundles, wherein said glass yarn fiber bundles comprises two or more of said glass yarn fibers are twisted together.

16. The method of claim 12, wherein said fibers are 0.008 to 0.02 inches in diameter.

17. The method of claim 12, wherein said fibers are coated with an insecticide or insect repellent.

18. The method of claim 12, wherein said glass yarn fiber is coated with a plastic.

19. The method of claim 18, said plastic is polyvinyl chloride.
